(19) United States
(12) Patent Application Publication
(10) Pub. No.: US 2003/0131756 A1
(43) Pub. Date: Jul. 17, 2003

(54) Complexes of anionic dyes and polyquaternary amines

(75) Inventors: Thomas W. Smith, Penfield, NY (US); Richard L. Colt, Rochester, NY (US); Kathleen M. McGrane, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/052,987

(22) Filed: Nov. 7, 2001

(51) Int. Cl. C09D 11/00; C09B 1/00; C09B 47/04; C09B 29/00

(52) U.S. Cl. 106/31.27; 106/31.43; 106/31.48; 106/31.5; 106/31.49; 8/673; 8/658; 8/688; 8/661

(57) ABSTRACT

Disclosed is a process which comprises (a) preparing a first solution comprising water and an anionic dye; (b) preparing a second solution comprising water and a polyquaternary amine compound; (c) admixing the first solution and the second solution, thereby causing formation of a complex of the anionic dye and the polyquaternary amine compound and precipitation of the complex from the solution; and (d) isolating the complex thus formed.

### BACKGROUND OF THE INVENTION

The present invention is directed to dye complexes, ink compositions and processes for the preparation thereof. More specifically, the present invention is directed to dye complexes and inks particularly suitable for use in ink jet printing processes. One embodiment of the present invention is directed to a process which comprises (a) preparing a first solution comprising water and an anionic dye; (b) preparing a second solution comprising water and a polyquaternary amine compound, (c) admixing the first solution and the second solution, thereby causing formation of a complex of the anionic dye and the polyquaternary amine compound and precipitation of the complex from the solution; and (d) isolating the complex thus formed.

Ink jet printing systems generally are of two types: continuous stream and drop-on-demand. In continuous stream ink jet systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field which adjusts the trajectory of each droplet in order to direct it to a gutter for recirculation or a specific location on a recording medium. In drop-on-demand systems, a droplet is expelled from an orifice directly to a position on a recording medium in accordance with digital data signals. A droplet is not formed or expelled unless it is to be placed on the recording medium.

Since drop-on-demand systems require no ink recovery, charging, or deflection, the system is much simpler than the continuous stream type. There are two types of drop-on-demand ink jet systems. One type of drop-on-demand system has as its major components an ink filled channel or passageway having a nozzle on one end and a piezoelectric transducer near the other end to produce pressure pulses. The relatively large size of the transducer prevents close spacing of the nozzles, and physical limitations of the transducer result in low ink drop velocity. Low drop velocity seriously diminishes tolerances for drop velocity variation and directionality, thus impacting the system's ability to produce high quality copies. Drop-on-demand systems which use piezoelectric devices to expel the droplets also suffer the disadvantage of a slow printing speed.

Another type of drop-on-demand system is known as thermal ink jet, or bubble jet, and produces high velocity droplets and allows very close spacing of nozzles. The major components of this type of drop-on-demand system are an ink filled channel having a nozzle on one end and a heat generating resistor near the nozzle. Printing signals representing digital information originate an electric current pulse in a resistive layer within each ink passageway near the orifice or nozzle, causing the ink in the immediate vicinity to evaporate almost instantaneously and create a bubble. The ink at the orifice is forced out as a propelled droplet as the bubble expands. When the hydrodynamic motion of the ink stops, the process is ready to start all over again. With the introduction of a droplet ejection system based upon thermally generated bubbles, commonly referred to as the “bubble jet” system, the drop-on-demand ink jet printers provide simpler, lower cost devices than their continuous stream counterparts, and yet have substantially the same high speed printing capability.

The operating sequence of the bubble jet system begins with a current pulse through the resistive layer in the ink filled channel, the resistive layer being in close proximity to the orifice or nozzle for that channel. Heat is transferred from the resistor to the ink. The ink becomes superheated far above its normal boiling point, and for water based ink, finally reaches the critical temperature for bubble formation or nucleation of around 280° C. Once nucleated, the bubble or water vapor thermally isolates the ink from the heater and no further heat can be applied to the ink. This bubble expands until all the heat stored in the ink in excess of the normal boiling point diffuses away or is used to convert liquid to vapor, which removes heat due to heat of vaporization. The expansion of the bubble forces a droplet of ink out of the nozzle, and once the excess heat is removed, the bubble collapses on the resistor. At this point, the resistor is no longer being heated because the current pulse has passed and, concurrently with the bubble collapse, the droplet is propelled at a high rate of speed in a direction towards a recording medium. The resistive layer encounters a severe cavitational force by the collapse of the bubble, which tends to erode it. Subsequently, the ink channel refills by capillary action. This entire bubble formation and collapse sequence occurs in about 10 microseconds. The channel can be refired after 100 to 500 microseconds minimum dwell time to enable the channel to be refilled and to enable the dynamic refilling factors to become somewhat dampened. Thermal ink jet processes are well known and are described in, for example, U.S. Pat. Nos. 4,601,777, 4,251,824, 4,410,899, 4,412,224, and 4,532,530, the disclosures of each of which are totally incorporated herein by reference.

Acoustic ink jet printing processes are also known. As is known, an acoustic beam exerts a radiation pressure against objects upon which it impinges. Thus, when an acoustic beam impinges on a free surface (i.e., liquid/air interface) of a pool of liquid from beneath, the radiation pressure which it exerts against the surface of the pool may reach a sufficiently high level to release individual droplets of liquid from the pool, despite the restraining force of surface tension. Focusing the beam on or near the surface of the pool intensifies the radiation pressure it exerts for a given amount of input power. These principles have been applied to prior ink jet and acoustic printing proposals. For example, K. A. Krause, “Focusing Ink Jet Head,” IBM Technical Disclosure Bulletin, Vol. 16, No. 4, September 1973, pp. 1168-1170, the disclosure of which is totally incorporated herein by reference, describes an ink jet in which an acoustic beam emanating from a concave surface and confined by a conical aperture was used to propel ink droplets out through a small ejection orifice. Acoustic ink printers typically comprise one or more acoustic radiators for illuminating the free surface of a pool of liquid ink with respective acoustic beams. Each of these beams usually is brought to focus at or near the surface of the reservoir (i.e., the liquid/air interface). Furthermore, printing conventionally is performed by independently modulating the excitation of the acoustic radiators in accordance with the input data samples for the image that is to be printed. This modulation enables the radiation pressure which each of the beams exerts against the free ink surface to make brief, controlled excursions to a sufficiently high pressure level for overcoming the restraining force of surface tension. That, in turn, causes individual droplets of ink to be ejected from the free ink surface on demand at an adequate velocity to cause them to deposit in an image configuration on a nearby recording medium. The acoustic beam may be intensity modulated or focused/defocused to control the ejection timing, or an external source may be used to extract droplets from the acoustically excited liquid on the surface of the pool on demand. Regardless of the timing mechanism employed, the size of the ejected droplets is determined by the waist diameter of the focused acoustic beam. Acoustic ink printing is attractive because it does not require the nozzles or the small ejection orifices which have caused many of the reliability and pixel placement accuracy problems that conventional drop-on-demand and continuous stream ink jet printers have suffered. The size of the ejection orifice is a critical design parameter of an ink jet because it determines the size of the droplets of ink that the jet ejects. As a result, the size of the ejection orifice cannot be increased, without sacrificing resolution. Acoustic printing has increased intrinsic reliability because there are no nozzles to clog. As will be appreciated, the elimination of the clogged nozzle failure mode is especially relevant to the reliability of large arrays of ink ejectors, such as page width arrays comprising several thousand separate ejectors. Furthermore, small ejection orifices are avoided, so acoustic printing can be performed with a greater variety of inks than conventional ink jet printing, including inks having higher viscosities and inks containing pigments and other particulate components. It has been found that acoustic ink printers embodying printheads comprising acoustically illuminated spherical focusing lenses can print precisely positioned pixels (i.e., picture elements) at resolutions which are sufficient for high quality printing of relatively complex images. It has also been discovered that the size of the individual pixels printed by such a printer can be varied over a significant range during operation, thereby accommodating, for example, the printing of variably shaded images. Furthermore, the known droplet ejector technology can be adapted to a variety of printhead configurations, including (1) single ejector embodiments for raster scan printing, (2) matrix configured ejector arrays for matrix printing, and (3) several different types of pagewidth ejector arrays, ranging from single row, sparse arrays for hybrid forms of parallel/serial printing to multiple row staggered arrays with individual ejectors for each of the pixel positions or addresses within a pagewidth image field (i.e., single ejector/pixel/line) for ordinary line printing. Inks suitable for acoustic ink jet printing typically are liquid at ambient temperatures (i.e., about 25° C.), but in other embodiments the ink is in a solid state at ambient temperatures and provision is made for liquefying the ink by heating or any other suitable method prior to introduction of the ink into the printhead. Images of two or more colors can be generated by several methods, including by processes wherein a single printhead launches acoustic waves into pools of different colored inks. Further information regarding acoustic ink jet printing apparatus and processes is disclosed in, for example, U.S. Pat. Nos. 4,308,547, 4,697,195, 5,028,937, 5,041,849, 4,751,529, 4,751,530, 4,751,534, 4,801,953, and 4,797,693, the disclosures of each of which are totally incorporated herein by reference. The use of focused acoustic beams to eject droplets of controlled diameter and velocity from a free-liquid surface is also described in J. Appl. Phys., vol. 65, no. 9 (May 1, 1989) and references therein, the disclosure of which is totally incorporated herein by reference.

Other known droplet ejectors include those of the type disclosed in, for example, U.S. Pat. No. 6,127,198, the disclosure of which is totally incorporated herein by reference.

U.S. Pat. No. 6,001,899 (Gundlach et al.), the disclosure of which is totally incorporated herein by reference, discloses an ink composition which comprises water, an anionic dye, and a polyquaternary amine compound selected from the group consisting of polydiallyl ammonium compounds, polyquaternized polyvinylamines, polyquaternized polyallylamines, and mixtures thereof. Also disclosed are methods for using the aforementioned ink composition in ink jet printing processes.

U.S. Pat. No. 6,054,505 (Gundlach et al.), the disclosure of which is totally incorporated herein by reference, discloses an ink composition which comprises (1) water; (2) a nonpolymeric salt comprising at least one cation and at least one anion; and (3) a colorant comprising an anionic dye complexed with a polyquaternary amine compound. Also disclosed is an ink composition which comprises (1) water; (2) a nonpolymeric salt comprising at least one cation and at least one anion; (3) an anionic dye; and (4) a polyquaternary amine compound. In one embodiment, the polyquaternary amine compound is selected from the group consisting of polydiallyl ammonium compounds, polyquaternized polyvinylamines, polyquaternized polyallylamines, epichlorohydrin/amine copolymers, cationic amido amine copolymers, copolymers of vinyl pyrrolidinone and a vinylimidazolium salt, and mixtures thereof.

U.S. Pat. No. 6,005,022 (Schwarz), the disclosure of which is totally incorporated herein by reference, discloses an ink composition which comprises (1) water; (2) a dye; and (3) a cationic amido amine copolymer. Also disclosed are methods for using the aforementioned ink composition in ink jet printing processes.

U.S. Pat. No. 5,990,198 (Schwarz), the disclosure of which is totally incorporated herein by reference, discloses an ink composition which comprises (1) water; (2) an anionic dye; and (3) a copolymer of vinyl pyrrolidinone and a vinylimidazolium salt. Also disclosed are methods for using the aforementioned ink compositions in ink jet printing processes.

U.S. Pat. No. 6,258,873 (Gundlach et al.), the disclosure of which is totally incorporated herein by reference, discloses an ink composition which comprises water, an acid dye, a monovalent salt, a polyquaternary amine compound, and an optional nonionic or cationic surfactant, said ink being substantially free of organic solvents. The ink is particularly suitable for applications such as ink jet printing and marking pens. The disclosed inks in some embodiments are substantially indelible. Also disclosed is a composition for removing the ink compositions from substrates to which they have been applied which comprises water and a dianionic surfactant, optionally further containing a salt, urea, and/or a viscosity building agent such as a gum.

U.S. Pat. No. 6,274,645 (Gundlach et al.), the disclosure of which is totally incorporated herein by reference, discloses a washing composition which comprises a linear alkyl diphenyl oxide disulfonate compound, a chloride, bromide, iodide, nitrate, acetylacetonate, polyphosphate, squarate, or sulfonate salt or mixtures thereof, and a cosolvent which is propylene glycol, dipropylene glycol, tripropylene glycol, diethylene glycol, glycerine, trimethylolethane, trimethylolpropane, or mixtures thereof.

U.S. Pat. No. 6,174,355 (Mayo et al.), the disclosure of which is totally incorporated herein by reference, discloses an ink composition comprising a colorant and poly(diallyl diethyl ammonium) bromide. Also disclosed are ink jet printing processes, including thermal ink jet and acoustic ink jet printing processes, for using the inks.

While known compositions and processes are suitable for their intended purposes, a need remains for improved aqueous inks. In addition, a need remains for aqueous inks particularly suitable for use in ink jet printing processes. Further, a need remains for ink compositions with improved waterfastness. Additionally, a need remains for ink compositions with improved wet smear resistance. There is also a need for ink compositions with reduced intercolor bleed when two or more colors are printed adjacent to each other. In addition, there is a need for ink compositions for ink jet printing which contain acid dyes, which enable advantages such as bright colors, low cost, and high waterfastness when complexed with cationic polymers. Further, there is a need for ink compositions with improved shelf stability. Additionally, there is a need for ink compositions with improved jetting characteristics. A need also remains for ink compositions which exhibit excellent smear resistance. In addition, a need remains for ink compositions which are heat stable. Further, a need remains for ink compositions which exhibit freeze/thaw stability. Additionally, a need remains for ink compositions suitable for use in ink jet printing processes and having relatively low viscosities. There is also a need for ink compositions with improved lighffastness. In addition, there is a need for ink compositions that, when used in ink jet printing processes, enable improved latency. Further, there is a need for ink compositions that, when used in ink jet printing processes, enable improved first missed drop response characteristics. Additionally, there is a need for ink compositions that, when used in ink jet printing processes, enable improved latency and first missed drop volumes while also exhibiting other good jetting characteristics. A need also remains for ink compositions with one or more of the above advantages that can be prepared at reduced cost.

### SUMMARY OF THE INVENTION

The present invention is directed to the preparation of new compositions of matter which comprise complexes of polyquaternary amines and anionic dyes. These complexes are prepared by a process which comprises (a) preparing a first solution comprising water and an anionic dye; (b) preparing a second solution comprising water and a polyquaternary amine compound; (c) admixing the first solution and the second solution, thereby causing formation of a complex of the anionic dye and the polyquaternary amine compound and precipitation of the complex from the solution; and (d) isolating the complex thus formed. The present invention also includes ink compositions containing the complexes of the present invention and processes for the preparation of these inks,

### DETAILED DESCRIPTION OF THE INVENTION

Ink compositions containing water, an anionic dye, and a polyquaternary amine compound are known, as disclosed in U.S. Pat. Nos. 6,001,899, 6,054,505, 6,005,022, 5,990,198, 6,258,873, and 6,274,645, the disclosures of each of which are totally incorporated herein by reference. The complex of a polyquaternary amine compound and an anionic dye can also be used as a colorant for other applications, including toners, textiles, flexographic inks, and the like.

When a complex of an anionic dye and a polyquaternary amine is prepared according to the process of the present invention, the complex so prepared, when used as a colorant in an ink for ink jet printing, enables printing with improved jetting characteristics compared to inks containing the same anionic dye and the same polyquaternary amine but prepared by simple mixing of the ink ingredients.

The process of the present invention entails (a) preparing a first solution comprising water and an anionic dye; (b) preparing a second solution comprising water and a polyquaternary amine compound; (c) admixing the first solution and the second solution, thereby causing formation of a complex of the anionic dye and the polyquaternary amine compound and precipitation of the complex from the solution; and (d) isolating the complex thus formed.

The polyquaternary amine compound is a polymer containing quaternary groups in the repeat units thereof. The polymer typically has a weight average molecular weight of from about 1,000 to about 10,000,000, preferably from about 3,000 to about 1,000,000, and more preferably from about 5,000 to about 400,000, although the value can be outside of these ranges. The polymer typically has a number average molecular weight of from about 800 to about 11,000,000, preferably from about 3,300 to about 1,100,000, and more preferably from about 5,600 to about 450,000, although the value can be outside of these ranges. The polymer typically has from about 5 to about 70,000 repeat monomer units therein, preferably from about 21 to about 7,000 repeat monomer units, and more preferably from about 35 to about 2,800 repeat monomer units, although the number of repeat monomer units can be outside of this range. Suitable polyquaternary amine compounds typically are of the general formulae

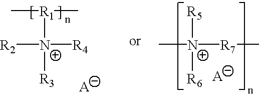

wherein n is an integer representing the number of repeat monomer units, R₁ and R₇ each, independently of the other, is an alkylene group, including saturated, unsaturated, cyclic, and substituted alkylene groups (wherein hetero atoms, such as oxygen, sulfur, nitrogen, silicon, phosphorus, and the like can be present in the alkylene group, and the alkylene groups including polymethylene oxide groups, polyethylene oxide groups, polypropylene oxide groups, and the like), typically with from 1 to about 30 carbon atoms and preferably with from 1 to about 6 carbon atoms, an arylene group, including substituted arylene groups, typically with from 6 to about 50 carbon atoms and preferably with from 6 to about 18 carbon atoms, an arylalkylene group, including substituted arylalkylene groups, typically with from 7 to about 60 carbon atoms and preferably with from 7 to about 20 carbon atoms, or an alkylarylene group, including substituted alkylarylene groups, typically with from 7 to about 60 carbon atoms and preferably with from 7 to about 20 carbon atoms, and R₂, R₃, R₄, R₅, and R₆ each, independently of the others, are hydrogen atoms, alkyl groups, including saturated, unsaturated, cyclic, and substituted alkyl groups (wherein hetero atoms, such as oxygen, sulfur, nitrogen, silicon, phosphorus, and the like can be present in the alkyl group), typically with from 1 to about 30 carbon atoms and preferably with from 1 to about 6 carbon atoms, aryl groups, including substituted aryl groups, typically with from 6 to about 50 carbon atoms and preferably with from 6 to about 18 carbon atoms, arylalkyl groups, including substituted arylalkyl groups, typically with from 7 to about 60 carbon atoms and preferably with from 7 to about 20 carbon atoms, or alkylaryl groups, including substituted alkylaryl groups, typically with from 7 to about 60 carbon atoms and preferably with from 7 to about 20 carbon atoms, wherein the substituents on the substituted alkyl, alkylene, aryl, arylene, arylalkyl, arylalkylene, alkylaryl, and alkylarylene groups can be (but are not limited to) hydroxy groups, amine groups, carbonyl groups, sulfide groups, halogen atoms, mixtures thereof, and the like, wherein two or more substituents can be joined together to form a ring.

Examples of suitable polyquaternary amine compounds include (but are not limited to) polydiallyl ammonium compounds, of the general formula

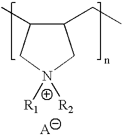

wherein n is an integer representing the number of repeat monomer units, R₁ and R₂ each, independently of the other, are hydrogen atoms, alkyl groups, including saturated, unsaturated, cyclic, and substituted alkyl groups (wherein hetero atoms, such as oxygen, sulfur, nitrogen, silicon, phosphorus, and the like can be present in the alkyl group), typically with from 1 to about 30 carbon atoms and preferably with from 1 to about 6 carbon atoms, aryl groups, including substituted aryl groups, typically with from 6 to about 50 carbon atoms and preferably with from about 6 to about 18 carbon atoms, arylalkyl groups, including substituted arylalkyl groups, typically with from about 7 to about 60 carbon atoms and preferably with from 7 to about 20 carbon atoms, or alkylaryl groups, including substituted alkylaryl groups, typically with from about 7 to about 60 carbon atoms and preferably with from 7 to about 20 carbon atoms, wherein the substituents on the substituted alkyl aryl, arylalkyl, and alkylaryl groups can be (but are not limited to) hydroxy groups, amine groups, carbonyl groups, sulfide groups, halogen atoms, mixtures thereof, and the like, wherein two or more substituents can be joined together to form a ring, and A is an anion, such as Cl⁻, Br⁻, I⁻, HSO₄⁻, HSO₃⁻, SO₄²⁻, SO₃²⁻, CH₃SO₃⁻, CH₃C₆H₄SO₃⁻, NO₃⁻, HCOO⁻, CH₃COO⁻, H₂PO₄⁻, HPO₄²⁻, SCN⁻, BF₄⁻, ClO₄⁻, SSO₃⁻, PF₆⁻, SbCl₆⁻, or the like, such as polydiallyl dimethyl ammonium compounds, including polydiallyl dimethyl ammonium chloride, of the formula

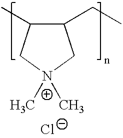

wherein n is an integer representing the number of repeat monomer units, commercially available with a molecular weight of about 400,000 (wherein n is an integer of about 2,500) from Calgon Corp. as 261-RV, and with a molecular weight of about 5,000 (wherein n is an integer of about 31) from Calgon Corp. as VARIKEM 110 or E2253.

Also suitable are polyquaternized polyvinylamines, of the general formula

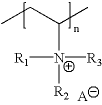

wherein n is an integer representing the number of repeat monomer units, R₁, R₂, and R₃ each, independently of the others, are hydrogen atoms, alkyl groups, including saturated, unsaturated, cyclic, and substituted alkyl groups (wherein hetero atoms, such as oxygen, sulfur, nitrogen, silicon, phosphorus, and the like can be present in the alkyl group), typically with from 1 to about 30 carbon atoms and preferably with from 1 to about 6 carbon atoms, aryl groups, including substituted aryl groups, typically with from 6 to about 50 carbon atoms and preferably with from about 6 to about 18 carbon atoms, arylalkyl groups, including substituted arylalkyl groups, typically with from 7 to about 60 carbon atoms and preferably with from 7 to about 20 carbon atoms, or alkylaryl groups, including substituted alkylaryl groups, typically with from 7 to about 60 carbon atoms and preferably with from 7 to about 20 carbon atoms, wherein the substituents on the substituted alkyl, aryl, arylalkyl, and alkylaryl groups can be (but are not limited to) hydroxy groups, amine groups, carbonyl groups, sulfide groups, halogen atoms, mixtures thereof, and the like, wherein two or more substituents can be joined together to form a ring, and A is an anion, such as Cl⁻, Br⁻, I⁻, HSO₄⁻, HSO₃⁻, SO₄²⁻, SO₃²⁻, CH₃SO₃⁻, CH₃C₆H₄SO₃⁻, NO₃⁻, HCOO⁻, CH₃COO⁻, H₂PO₄⁻, HPO₄²⁻, SCN⁻, BF₄⁻, ClO₄⁻, SSO₃⁻, PF₆⁻, SbCl₆⁻, or the like.

Also suitable are polyquaternized polyallylamines, of the general formula

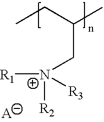

wherein n is an integer representing the number of repeat monomer units, R₁, R₂, and R₃ each, independently of the others, are hydrogen atoms, alkyl groups, including saturated, unsaturated, cyclic, and substituted alkyl groups (wherein hetero atoms, such as oxygen, sulfur, nitrogen, silicon, phosphorus, and the like can be present in the alkyl group), typically with from 1 to about 30 carbon atoms and preferably with from 1 to about 6 carbon atoms, aryl groups, including substituted aryl groups, typically with from 6 to about 50 carbon atoms and preferably with from about 6 to about 18 carbon atoms, arylalkyl groups, including substituted arylalkyl groups, typically with from 7 to about 60 carbon atoms and preferably with from 7 to about 20 carbon atoms, or alkylaryl groups, including substituted alkylaryl groups, typically with from 7 to about 60 carbon atoms and preferably with from 7 to about 20 carbon atoms, wherein the substituents on the substituted alkyl, aryl, arylalkyl, and alkylaryl groups can be (but are not limited to) hydroxy groups, amine groups, carbonyl groups, sulfide groups, halogen atoms, mixtures thereof, and the like, wherein two or more substituents can be joined together to form a ring, and A is an anion, such as Cl⁻, Br⁻, I⁻, HSO₄⁻, HSO₃⁻, SO₄²⁻, SO₃²⁻, CH₃SO₃⁻, CH₃C₆H₄SO₃⁻, NO₃⁻, HCOO⁻, CH₃COO⁻, H₂PO₄⁻, HPO₄²⁻; SCN⁻, BF₄⁻, ClO₄⁻, SSO₃⁻, PF₆⁻, SbCl₆⁻, or the like.

Also suitable are epichlorohydrin/amine copolymers, including those of the general formula

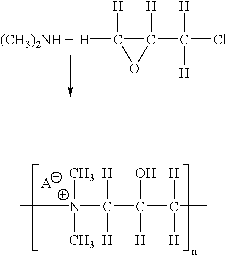

wherein n is an integer of from about 3 to about 3,000, and preferably from about 5 to about 100, although the value can be outside of these ranges, and A is any suitable or desired anion, such as Cl⁻, Br⁻, I⁻, HSO₄⁻, HSO₃⁻, SO₄²⁻, SO₃²⁻, CH₃SO₃⁻, CH₃C₆H₄SO₃⁻, NO₃⁻, HCOO⁻, CH₃COO⁻, H₂PO₄⁻, HPO₄²⁻, SCN⁻, BF₄⁻, ClO₄⁻, SSO₃⁻, PF₆⁻, SbCl₆⁻, or the like. Polymers of this formula are commercially available from Hercules, Wilmington, Del. as RETEN 200 or RETEN 201 (molecular weight generally less than 10,000), and from Cytex, Inc., West Patterson, N.J., as CYPRO 514, 515, and 516 (wherein the polymers have a molecular weight range of from about 75,000 to about 250,000 and n is from about 870 to about 3,000), and as SUPERFLOC C567 (wherein the polymer has a molecular weight of about 10,000 and n is from about 110 to about 120, typically about 116).

Also suitable are cationic amido amine copolymers. Examples of suitable cationic amido amine copolymers include those of the general formula

(A−B)ₙ²ⁿ⁺·2nX⁻

wherein X is an anion, such as Cl⁻, Br⁻, I⁻, HSO₄⁻, HSO₃⁻, SO₄²⁻, S₃²⁻, CH₃SO₃⁻, CH₃C₆H₄SO₃⁻, NO₃⁻, HCOO⁻, CH₃COO⁻, H₂PO₄⁻, HPO₄²⁻, SCN⁻, BF₄⁻, ClO₄⁻, SSO₃⁻, PF₆⁻, SbCl₆⁻, or the like, n is an integer representing the number of repeating monomer units, and typically is from about 2 to about 1,000, preferably from about 3 to about 200, more preferably from about 3 to about 100, and even more preferably from about 3 to about 10, although the value can be outside of these ranges, “A” is

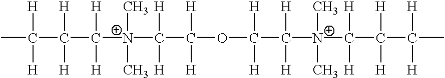

and “B” is selected from the group consisting of (a) monomers of the formula

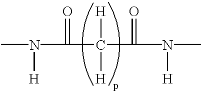

wherein p is an integer representing the number of repeat monomer units, and typically is from 1 to about 12, preferably from 1 to about 7, and more preferably from 1 to about 4, although the value can be outside of these ranges, such as (i) azeleic acid diamido, wherein p is 7, of the formula

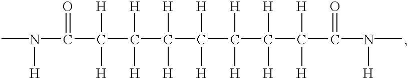

or (ii) adipic acid diamido, wherein p is 4, of the formula

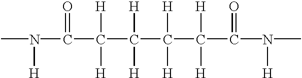

and (b) ureido, of the formula

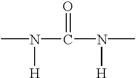

Mixtures of two or more “B” monomers can also be used within the polymer. In a preferred embodiment, these specific polymers typically are condensation polymers, with alternating “A” and “B” monomer units. The weight average molecular weight of the polymer typically is from about 1,000 to about 100,000, preferably from about 1,000 to about 30,000, and more preferably from about 2,000 to about 5,000, although the value can be outside of these ranges. Copolymers of an amine and an amide are commercially available from, for example, Rhone-Poulenc, Cranbury, N.J., as, for example, MIRAPOL AZ-1, of the above formula wherein the “B” monomer is azeleic acid diamido, n has an average value of about 100, and the molecular weight is about 50,000, MIRAPOL AD-1, of the above formula wherein the “B” monomer is adipic acid diamido, n has an average value of about 100, and the molecular weight is about 50,000, and MIRAPOL A-15, of the above formula wherein the “B” monomer is ureido, n has an average value of about 6, and the molecular weight is about 2,260.

Also suitable are copolymers of vinyl pyrrolidinone and a vinylimidazolium salt. In one embodiment, the copolymer is of a vinyl imidazolium salt of the formula

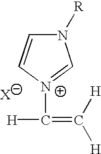

wherein X is an anion and R is a hydrogen atom or an alkyl group, typically with from 1 to about 8 carbon atoms and preferably with from 1 to about 3 carbon atoms, and vinyl pyrrolidinone, of the formula

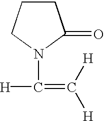

wherein the copolymer is of the general formula

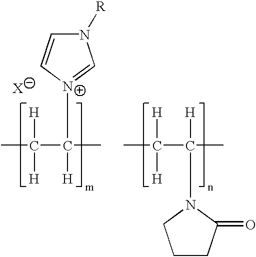

wherein X is any suitable or desired anion, such as Cl⁻, Br⁻, I⁻, HSO₄⁻, HSO₃⁻, SO₄²⁻, SO₃²⁻, CH₃SO₃⁻, CH₃C₆H₄SO₃⁻, NO₃⁻, HCOO⁻, CH₃COO⁻, H₂PO₄⁻, HPO₄²⁻, SCN⁻, BF₄⁻, ClO₄⁻, SSO₃⁻, PF₆⁻, SbCl₆⁻, or the like, R is a hydrogen atom or an alkyl group, typically with from 1 to about 8 carbon atoms, and preferably with from 1 to about 3 carbon atoms, m is a integer representing the number of repeat vinylimidazolium units, and n is an integer representing the number of repeat vinyl pyrrolidinone units. When R is a hydrogen atom, the pH of the ink can be adjusted to provide optimal ink-paper interaction; for example, the hydrogen atom can be extracted upon contact with the paper, or the cationic character of the polymer can be adjusted with ink pH. Random copolymers of the above formula generally are preferred, although alternating and block copolymers are also suitable. The weight average molecular weight of the polymer typically is from about 1,000 to about 1,000,000, preferably from about 1,000 to about 100,000, and more preferably from about 2,000 to about 5,000, although the value can be outside of these ranges. The ratio of vinylimidazolium monomers to vinyl pyrrolidinone monomers typically is from about 99:1 to about 5:95, preferably from about 95:5 to about 20:80, more preferably from about 95:5 to about 30:70, and even more preferably from about 95:5 to about 50:50, although the value can be outside of these ranges. Vinyl pyrrolidinone/vinylimidazolium salt copolymers are commercially available; for example, BASF, Parsippany, N.J., provides vinylimidazolium chloride/vinyl pyrrolidinone copolymers (of the above formula wherein R is CH₃) with a molecular weight of about 100,000 in three monomer ratios: LUVIQUAT® FC905 has a vinylimidazolium chloride:vinyl pyrrolidinone ratio of 95:5 with 6.7 milliequivalents per gram of cationic groups, LUVIQUAT® FC550 has a vinylimidazolium chloride:vinyl pyrrolidinone ratio of 50:50 with 3.0 milliequivalents per gram of cationic groups, and LUVIQUAT® FC370 has a vinylimidazolium chloride:vinyl pyrrolidinone ratio of 30:70 with 1.8 milliequivalents per gram of cationic groups. Also available from BASF is LUVIQUAT® HM552, with a molecular weight of about 800,000 and a vinyl imidazolium chloride:vinyl pyrrolidinone ratio of 50:50.

Mixtures of two or more polyquaternary amine compounds can also be employed.

Any suitable anionic dye or mixture of anionic dyes can be used. Examples of suitable dyes include Food dyes such as Food Black No. 1, Food Black No. 2, Food Red No. 40, Food Blue No. 1, Food Yellow No. 7, and the like, FD & C dyes, Acid Black dyes (No. 1, 7, 9, 24, 26, 48, 52, 58, 60, 61, 63, 92, 107, 109, 118, 119, 131, 140, 155, 156, 172, 194, and the like), Acid Red dyes (No. 1, 8, 32, 35, 37, 52, 57, 92, 115, 119, 154, 249, 254, 256, and the like), Acid Blue dyes (No. 1, 7, 9, 25, 40, 45, 62, 78, 80, 92, 102, 104, 113, 117, 127, 158, 175, 183, 193, 209, and the like), Acid Yellow dyes (No. 3, 7, 17, 19, 23, 25, 29, 38, 42, 49, 59, 61, 72, 73, 114, 128, 151, and the like), Direct Black dyes (No. 4, 14, 17, 22, 27, 38, 51, 112, 117, 154, 168, and the like), Direct Blue dyes (No. 1, 6, 8, 14, 15, 25, 71, 76, 78, 80, 86, 90, 106, 108, 123, 163, 165, 199, 226, and the like), Direct Red dyes (No. 1, 2, 16, 23, 24, 28, 39, 62, 72, 236, and the like), Direct Yellow dyes (No. 4, 11, 12, 27, 28, 33, 34, 39, 50, 58, 86, 100, 106, 107, 118, 127, 132, 142, 157, and the like), anthraquinone dyes, monoazo dyes, disazo dyes, phthalocyanine derivatives, including various phthalocyanine sulfonate salts, aza(18)annulenes, formazan copper complexes, triphenodioxazines, Bernacid Red 2BMN; Pontamine Brilliant Bond Blue A; Pontamine; Caro direct Turquoise FBL Supra Conc. (Direct Blue 199), available from Carolina Color and Chemical; Special Fast Turquoise 8GL Liquid (Direct Blue 86), available from Mobay Chemical; Intrabond Liquid Turquoise GLL (Direct Blue 86), available from Crompton and Knowles; Cibracron Brilliant Red 38-A (Reactive Red 4), available from Aldrich Chemical; Drimarene Brilliant Red X-2B (Reactive Red 56), available from Pylam, Inc., Levafix Brilliant Red E-4B, available from Mobay Chemical; Levafix Brilliant Red E-6BA, available from Mobay Chemical; Procion Red H₈B (Reactive Red 31), available from ICI America; Pylam Certified D&C Red #28 (Acid Red 92), available from Pylam; Direct Brilliant Pink B Ground Crude, available from Crompton & Knowles; Cartasol Yellow GTF Presscake, available from Sandoz, Inc.; Tartrazine Extra Conc. (FD&C Yellow #5, Acid Yellow 23), available from Sandoz; Carodirect Yellow RL (Direct Yellow 86), available from Carolina Color and Chemical; Cartasol Yellow GTF Liquid Special 110, available from Sandoz, Inc.; D&C Yellow # 10 (Acid Yellow 3), available from Tricon; Yellow Shade 16948, available from Tricon, Basacid Black X34, available from BASF, Carta Black 2GT, available from Sandoz, Inc.; Neozapon Red 492 (BASF); Savinyl Blue GLS (Sandoz); Luxol Blue MBSN (Morton-Thiokol), Basacid Blue 750 (BASF); Bernacid Red, available from Berncolors, Poughkeepsie, N.Y.; Pontamine Brilliant Bond Blue; Berncolor A.Y. 34, Telon Fast Yellow 4GL-175; BASF Basacid Black SE 0228; the Pro-Jet® series of dyes available from ICI, including Pro-Jet® Yellow I (Direct Yellow 86), Pro-Jet® Magenta I (Acid Red 249), Pro-Jet® Cyan I (Direct Blue 199), Pro-Jet® Black I (Direct Black 168), Pro-Jet® Yellow 1-G (Direct Yellow 132), Aminyl Brilliant Red F-B, available from Sumitomo Chemical Company (Japan), the Duasyn® line of “salt-free” dyes available from Hoechst, such as Duasyn® Direct Black HEF-SF (Direct Black 168), Duasyn® Black RL-SF (Reactive Black 31), Duasyn® Direct Yellow 6G-SF VP216 (Direct Yellow 157), Duasyn® Brilliant Yellow GL-SF VP220 (Reactive Yellow 37), Duasyn® Acid Yellow XX-SF LP413 (Acid Yellow 23), Duasyn® Brilliant Red F3B-SF VP218 (Reactive Red 180), Duasyn® Rhodamine B-SF VP353 (Acid Red 52), Duasyn® Direct Turquoise Blue FRL-SF VP368 (Direct Blue 199), Duasyn® Acid Blue AE-SF VP344 (Acid Blue 9), various Reactive dyes, including Reactive Black dyes, Reactive Blue dyes, Reactive Red dyes, Reactive Yellow dyes, and the like, as well as mixtures thereof.

The first solution is prepared by admixing an anionic dye in water. The anionic dye is present in the water solution in any desired or effective amount, typically at least about 1 percent by weight of the water solution, preferably at least about 2 percent by weight of the water solution, and more preferably at least about 5 percent by weight of the water solution, and typically no more than about 50 percent by weight of the water solution, preferably no more than about 20 percent by weight of the water solution, and more preferably no more than about 10 percent by weight of the water solution, although the amount can be outside of these ranges.

The second solution is prepared by admixing a polyquaternary amine compound in water. The polyquaternary amine compound is present in the water solution in any desired or effective amount, typically at least about 1 percent by weight of the water solution, preferably at least about 2 percent by weight of the water solution, and more preferably at least about 5 percent by weight of the water solution, and typically no more than about 50 percent by weight of the water solution, preferably no more than about 20 percent by weight of the water solution, and more preferably no more than about 10 percent by weight of the water solution, although the amount can be outside of these ranges.

Thereafter, the first solution and the second solution are admixed, thereby causing formation of a complex of the anionic dye and the polyquaternary amine compound and precipitation of the complex from the solution. The first solution and the second solution can be admixed in any desired or effective relative amounts. Typically, the first and second solutions are admixed in relative amounts such that the number of moles of anionic sites on the dye molecule and the number of moles of cationic sites on the polyquaternary amine molecule are approximately stoichiometric. Typically, the first and second solutions are admixed in relative amounts such that the resulting combined solution contains at least about 0.25 mole of anionic sites on the dye molecule for every mole of cationic sites on the polyquaternary amine molecule, preferably at least about 0.5 mole of anionic sites on the dye molecule for every mole of cationic sites on the polyquaternary amine molecule, and more preferably at least about 0.75 mole of anionic sites on the dye molecule for every mole of cationic sites on the polyquaternary amine molecule, and typically no more than about 2 moles of anionic sites on the dye molecule for every mole of cationic sites on the polyquaternary amine molecule, preferably no more than about 1.5 moles of anionic sites on the dye molecule for every mole of cationic sites on the polyquaternary amine molecule, and more preferably no more than about 1 mole of anionic sites on the dye molecule for every mole of cationic sites on the polyquaternary amine molecule, although the relative amounts can be outside of these ranges.

Upon admixture and stirring of the first solution and the second solution, a complex of the dye and the polyquaternary amine compound precipitates from the combined aqueous solution formed upon admixture. The precipitated complex is isolated by any standard or desired technique, such as filtration, centrifugation, or the like followed by drying. Drying can take place at ambient temperature (typically from about 20 to 25° C.), or can, if desired, be accelerated by exposure to vacuum and/or heat up to about 100° C. In one instance a procedure wherein the filtered precipitate was first allowed to air dry followed by drying in a vacuum oven at about 60° C. was found to work well. Drying is continued until the dried complex has achieved a constant weight, indicating near complete removal of the water from the complex.

To determine the amount of dye present in the dried complex and the ratio of dye to polyquaternary amine in the complex, ¹H NMR spectroscopy can be employed. For example, the complex can be dissolved in deuterated water (D₂O) containing a salt to enhance solubility of the complex in the deuterated water (for example, an aqueous solution of 10 percent by weight magnesium chloride) and the solution can be used to obtain a ¹H NMR spectrum.

The number of anionic sites on the dye molecule for every cationic site on the polyquaternary amine molecule found in the complex tend to be about the same regardless of the relative amounts of dye and polyquaternary amine admixed. Even when the dye is present in a limited amount, the complex which does precipitate tends to have a number of anionic sites on the dye molecule for every cationic site on the polyquaternary amine molecule similar to those obtained when the dye is present in excess. In addition, in the complex, the number of anionic sites on the dye molecule for every cationic site on the polyquaternary amine molecule tends to be about the same regardless of the molecular weight of the polyquaternary amine provided that the polyquaternary amine has the same repeat monomer units in both instances.

The number of cationic sites on the polyquaternary amine molecule for every anionic site on the dye molecule found in the complex differ for each dye and for each polyquaternary amine. For example, in a complex of Acid Yellow 23 dye (tartrazine) (which has 3 anionic sites per molecule (two —SO₃⁻ groups and one —COO⁻ group)), with a poly(dimethyldiallyl ammonium chloride) having a weight average molecular weight of about 10,000 (CALGON® CP1030) (wherein each repeat monomer unit has one cationic site), the molar ratio of dye molecules to repeat monomer units is about 1:2.7, which is about 0.9 cationic site on the polyquaternary amine molecule for every anionic site on the dye molecule.

In a complex of Acid Red 52 dye (which has 2 anionic sites per molecule), with a poly(dimethyldiallyl ammonium chloride) having a weight average molecular weight of about 10,000 (CALGON® CP1030) (wherein each repeat monomer unit has one cationic site), the molar ratio of dye molecules to repeat monomer units is about 1:2, which is about 1.0 cationic sites on the polyquaternary amine molecule for every anionic site on the dye molecule.

In a complex of the chlorotriazine dye PROJET® MAGENTA 3BOA (molecular weight 881 grams per mole; C₃₀H₂₀ClN₇O₁₅S₄) (which has 4 anionic sulfonate sites per molecule), with a poly(dimethyldiallyl ammonium chloride) having a weight average molecular weight of about 10,000 (CALGON® CP1030) (wherein each repeat monomer unit has one cationic site), the molar ratio of dye molecules to repeat monomer units is about 1:5, which is about 0.8 cationic sites on the polyquaternary amine molecule for every anionic site on the dye molecule.

In a complex of ILFORD YELLOW Y-104 dye, of the formula

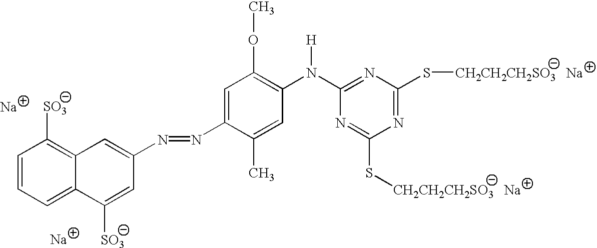

(which has 4 anionic sites per molecule), with a poly(dimethyldiallyl ammonium chloride) having a weight average molecular weight of about 10,000 (CALGON® CP1030) (wherein each repeat monomer unit has one cationic site), the molar ratio of dye molecules to repeat monomer units is about 1:3.25, which is about 0.8125 cationic sites on the polyquaternary amine molecule for every anionic site on the dye molecule.

In a complex of ILFORD YELLOW Y-104 dye (which has 4 anionic sites per molecule), with a poly(dimethyldiallyl ammonium chloride) having a weight average molecular weight of about 100,000 (MAGNIFLOC® 58C) (wherein each repeat monomer unit has one cationic site), the molar ratio of dye molecules to repeat monomer units is about 1:4.3, which is about 1.075 cationic sites on the polyquaternary amine molecule for every anionic site on the dye molecule.

In a complex of ILFORD YELLOW Y-104 dye (which has 4 anionic sites per molecule), with a copoly(N-vinyl-N-methylimidazolium chloride/N-vinylpyrrolidone)(95/5)w having a weight average molecular weight of about 40,000 (LUVIQUAT® FC 905) (wherein each repeat monomer unit has one cationic site), the molar ratio of dye molecules to repeat monomer units is about 1:3.3, which is about 0.825 cationic sites on the polyquaternary amine molecule for every anionic site on the dye molecule.

In a complex of ILFORD MAGENTA M-377 dye, of the formula

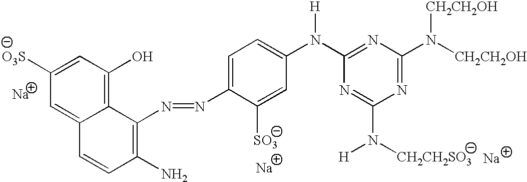

(which has 3 anionic sites per molecule), with a poly(dimethyldiallyl ammonium chloride) having a weight average molecular weight of about 10,000 (CALGON® CP1030) (wherein each repeat monomer unit has one cationic site), the molar ratio of dye molecules to repeat monomer units is about 1:3.5, which is about 1.167 cationic sites on the polyquaternary amine molecule for every anionic site on the dye molecule.

In a complex of Acid Blue 9 dye (which has 2 anionic sites per molecule), with a poly(dimethyldiallyl ammonium chloride) having a weight average molecular weight of about 10,000 (CALGON® CP1030) (wherein each repeat monomer unit has one cationic site), the molar ratio of dye molecules to repeat monomer units is about 1:2, which is about 1.0 cationic sites on the polyquaternary amine molecule for every anionic site on the dye molecule.

In a complex of Direct Blue 199 dye (which has 3 anionic sites per molecule), with a poly(dimethyldiallyl ammonium chloride) having a weight average molecular weight of about 10,000 (CALGON® CP1030) (wherein each repeat monomer unit has one cationic site), the molar ratio of dye molecules to repeat monomer units is about 1:4.4, which is about 1.47 cationic sites on the polyquaternary amine molecule for every anionic site on the dye molecule.

Ink compositions can be prepared from the complexes thus formed by admixing the complex with the other desired ink ingredients. Any order of addition of ingredients can be used. In one instance, a process wherein the dye/polyquaternary amine complex was admixed first with the ink cosolvents and/or humectants, followed by admixing that mixture with water and the salts to be present in the ink, was found to work well.

Inks of the present invention contain an aqueous liquid vehicle and a complex of an anionic dye and a polyquaternary amine compound. The liquid vehicle generally comprises a mixture of water and a water soluble or water miscible organic component, such as ethylene glycol, propylene glycol, diethylene glycols, glycerine, dipropylene glycols, polyethylene glycols, polypropylene glycols, amides, ethers, urea, substituted ureas, ethers, carboxylic acids and their salts, esters, alcohols, organosulfides, organosulfoxides, sulfones (such as sulfolane), alcohol derivatives, carbitol, butyl carbitol, cellusolve, tripropylene glycol monomethyl ether, ether derivatives, amino alcohols, ketones, N-methylpyrrolidinone, 2-pyrrolidinone, cyclohexylpyrrolidone, hydroxyethers, amides, sulfoxides, lactones, polyelectrolytes, methyl sulfonylethanol, imidazole, betaine, and other water soluble or water miscible materials, as well as mixtures thereof. When mixtures of water and water soluble or miscible organic liquids are selected as the liquid vehicle, the water to organic ratio typically ranges from about 100:0 to about 30:70, and preferably from about 97:3 to about 40:60. The non-water component of the liquid vehicle generally serves as a humectant or cosolvent which has a boiling point higher than that of water (100° C.). In the ink compositions of the present invention, the liquid vehicle is typically present in an amount of from about 80 to about 99.9 percent by weight of the ink, and preferably from about 90 to about 99 percent by weight of the ink, although the amount can be outside these ranges.

The anionic dye/polyquaternary amine complex is present in the ink in any desired or effective amount, typically at least about 1 percent by weight of the ink preferably at least about 2 percent by weight of the ink, and more preferably at least about 5 percent by weight of the ink, and typically no more than about 20 percent by weight of the ink, preferably no more than about 15 percent by weight of the ink, and more preferably no more than about 10 percent by weight of the ink, although the amount of complex in the ink can be outside of these ranges. The amount of anionic dye/polyquaternary amine complex in the ink can also be expressed in terms of the amount of dye molecules present in the ink to obtain the desired color, hue, or intensity. The anionic dye itself is present in the ink in an amount of typically at least about 1 percent by weight of the ink, preferably at least about 2 percent by weight of the ink, and more preferably at least about 3 percent by weight of the ink, and typically no more than about 10 percent by weight of the ink, preferably no more than about 7 percent by weight of the ink, and more preferably no more than about 5 percent by weight of the ink, although the amount of dye in the ink can be outside of these ranges.

The inks of the present invention further preferably contain a nonpolymeric salt comprising at least one cation and at least one anion. Examples of suitable cations include alkali metal cations, such as Li⁺, Na⁺, and K⁺, alkaline earth metal cations, such as Mg²⁺ and Ca²⁺, Al³⁺, nonpolymeric or monomeric ammonium and quaternary amine cations, including those of the general formula

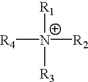

wherein each of R₁, R₂, R₃, and R₄, independently of the others, is a hydrogen atom, an alkyl group (including saturated, unsaturated, cyclic, and substituted alkyl groups, wherein substituted alkyl groups can include alkoxy or polyalkoxy groups such as ethylene oxide, polyethylene oxide, or the like), preferably with from 1 to about 10 carbon atoms and more preferably with from 1 to about 4 carbon atoms, although the number of carbon atoms can be outside of this range, aryl groups, including substituted aryl groups, preferably with from 6 to about 18 carbon atoms and more preferably with from 6 to about 12 carbon atoms, although the number of carbon atoms can be outside of this range, arylalkyl groups, including substituted arylalkyl groups, preferably with from 7 to about 20 carbon atoms and more preferably with from 7 to about 13 carbon atoms, or alkylaryl groups, including substituted alkylaryl groups, preferably with from 7 to about 20 carbon atoms and more preferably with from 7 to about 13 carbon atoms, wherein the substituents on the substituted alkyl, aryl, arylalkyl, and alkylaryl groups can be (but are not limited to) hydroxy groups, amine groups, ammonium groups, cyano groups, pyridine groups, pyridinium groups, ether groups, aldehyde groups, ketone groups, ester groups, amide groups, carbonyl groups, sulfide groups, sulfoxide groups, phosphine groups, phosphonium groups, nitrile groups, mercapto groups, nitroso groups, halogen atoms, nitro groups, sulfone groups, acyl groups, mixtures thereof, and the like, wherein two or more substituents can be joined together to form a ring, with specific examples of ammonium and quaternary amine cations including NH₄⁺, N(CH₃)₄^{+, H}₃NCH₂CH₂NH₃²⁺, (H₃C)₃NCH₂CH₂N(CH₃)₃²⁺, imidazolium, quaternized 1,4-diazabicyclo(2.2.2)octane, choline, of the formula

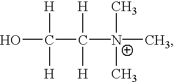

alkyl amine quaternary salts such as ETHOQUAD C/12, of the formula

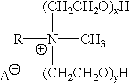

wherein R is a long chain alkyl group with 12 carbon atoms, x and y are integers of 0, 1, or 2 representing the number of ethoxy groups, wherein x+y=2, and A is an anion, such as chloride, commercially available from Akzo Chemie, Chicago, Ill., and the like, as well as mixtures thereof. Any desired anion can be employed. Examples of suitable anions include NO₃⁻, ClO₄⁻, SO₄²⁻, PF₆⁻, BF₄⁻, organic acid anions, such as tosylate, mesylate, triflate, trifluoroacetate, sulfamate, and the like, and including weak organic acid anions such as formate, acetate, propionate, and the like, acetylacetonate, of the formula

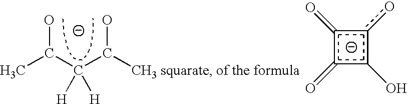

halides, including chloride, bromide, and iodide, and the like, as well as mixtures thereof. Specific examples of suitable salts include lithium chloride, lithium bromide, lithium iodide, lithium nitrate, lithium formate, lithium acetate, lithium propionate, sodium chloride, sodium bromide, sodium iodide, sodium nitrate, sodium perchlorate, sodium formate, sodium acetate, sodium propionate, potassium chloride, potassium bromide, potassium iodide, potassium formate, potassium acetate, potassium propionate, calcium chloride, calcium nitrate, calcium formate, calcium acetate, calcium propionate, magnesium chloride, magnesium sulfate, magnesium formate, magnesium acetate, magnesium propionate, ammonium chloride, ammonium bromide, ammonium iodide, ammonium acetate, ammonium formate, ammonium nitrate, ammonium sulfate, ammonium propionate, tetramethylammonium chloride, tetramethylammonium formate, tetramethylammonium acetate, tetramethylammonium propionate, ethylene diamine dihydrochloride, 1,4-diazabicyclo(2.2.2)octane salts, such as hexamethonium bromide, of the formula

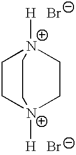

imidazole salts, such as imidazolium chloride, acetylacetonate salts, such as lithium acetylacetonate, squarate salts, such as tetramethylammonium squarate, choline salts, such as choline chloride, ETHOQUAD C/12, and the like. The salt is present in the ink in any desired or effective amount, typically at least about 0.1 percent by weight of the ink, preferably at least about 1 percent by weight of the ink, and more preferably at least about 5 percent by weight of the ink, and typically no more than about 40 percent by weight of the ink, preferably no more than about 30 percent by weight of the ink, more preferably no more than about 20 percent by weight of the ink, and even more preferably no more than about 15 percent by weight of the ink, although the amount can be outside of these ranges.

While not being limited to any particular theory, it is believed that the presence of the salt suppresses the extent to which the complex is associated in solution and thereby solubilizes the dye/polyquaternary amine in the inks of the present invention. Again, while not being limited to any particular theory, it is believed that within the ink, the polyquaternary amine tends to be associated with the anionic dye, with the dye playing the role of a counterion. This complex is rendered soluble in the ink vehicle by virtue of the presence of water soluble ionic salts, the anions of which limit the extent of association of anionic dyes with the quaternary polymer in solution. The presence of the salt in the first ink can also reduce jitter when the ink is jetted and increase ink surface tension.

Other optional additives to the inks include biocides such as Dowicil 150, 200, and 75, benzoate salts, sorbate salts, and the like, present in an amount of from about 0.0001 to about 4 percent by weight of the ink, and preferably from about 0.01 to about 2.0 percent by weight of the ink, pH controlling agents such as acids or, bases, phosphate salts, carboxylates salts, sulfite salts, amine salts, and the like, present in an amount of from 0 to about 1 percent by weight of the ink and preferably from about 0.01 to about 1 percent by weight of the ink, or the like.

When used in ink jet printing applications, the ink compositions according to the present invention are generally of a viscosity suitable for use in said ink jet printing processes. For example, for thermal ink jet printing applications, at room temperature (i.e., about 25° C.), typically, the ink viscosity is typically at least about 1 centipoise and typically is up to about 10 centipoise, preferably up to about 5 centipoise, and more preferably up to about 4 centipoise, although the viscosity can be outside these ranges, particularly when the ink is used for applications such as acoustic ink jet printing. When used in marking pen applications, the ink compositions are generally of a viscosity suitable for use in said applications.

The ink compositions can be of any suitable or desired pH. For some embodiments, such as thermal ink jet printing processes, typical pH values are at least about 3, preferably at least about 5, and more preferably at least about 6, and typically up to about 11, preferably up to about 10, and more preferably up to about 9, although the pH can be outside of these ranges.

The ink compositions of the present invention can be used in a process which entails incorporating the ink composition into an ink jet printing apparatus and causing droplets of the ink composition to be ejected in an imagewise pattern onto a substrate. In a particularly preferred embodiment, the printing apparatus employs a thermal ink jet process wherein the ink in the nozzles is selectively heated in an imagewise pattern, thereby causing droplets of the ink to be ejected in imagewise pattern. In another embodiment, the printing apparatus employs an acoustic ink jet process wherein droplets of the ink are caused to be ejected in imagewise pattern by acoustic beams. In yet another embodiment, the printing apparatus employs a piezoelectric ink jet process, wherein droplets of the ink are caused to be ejected in imagewise pattern by oscillations of piezoelectric vibrating elements. Any suitable substrate can be employed, including plain papers such as Xerox® 4024 papers, Xerox® Image Series papers, Courtland 4024 DP paper, ruled notebook paper, bond paper, silica coated papers such as Sharp Company silica coated paper, JuJo paper, and the like, transparency materials, fabrics, textile products, plastics, polymeric films, inorganic substrates such as metals and wood, and the like. In a preferred embodiment, the process entails printing onto a porous or ink absorbent substrate, such as plain paper.

Specific embodiments of the invention will now be described in detail. These examples are intended to be illustrative, and the invention is not limited to the materials, conditions, or process parameters set forth in these embodiments. All parts and percentages are by weight unless otherwise indicated.

The dye/polymer complexes of Examples I to VI were prepared by diluting the as-received commercially obtained solutions of the quaternary polymer (CALGON® CP-1030) and the anionic dyes with deionized water to generate approximately 5 percent by weight solids aqueous solutions. These solutions were mixed (adding the dye solution to a stirred solution of the quaternary polymer). A precipitate formed immediately in each case and was isolated by centrifugation.

### EXAMPLE I

### Synthesis of Poly(Dimethyldiallyammonium/Acid Yellow 23) Complex

In the preparation of the poly(dimethyldiallyammonium/Acid Yellow 23) complex, 1 mole of Acid Yellow 23 was mixed with 4 molar repeat residues (C₈H₆N⁺) of the poly(dimethyldiallyammonium chloride) to yield a precipitate that comprised 2.7 C₈H₆N⁺ residues per mole of Acid Yellow 23. This complex was used in the preparation of the inks of Examples VIII and X.

### EXAMPLE II

### Synthesis of poly(dimethyldiallyammonium/Acid Red 52) Complex

In the preparation of the poly(dimethyldiallyammonium/Acid Red 52) complex, 1 mole of Acid Red 52 was mixed with 3 molar repeat residues (C₈H₆N⁺) of the poly(dimethyldiallyammonium chloride) to yield a precipitate that comprised 2.0 C₈H₆N⁺ residues per mole of Acid Red 52.

### EXAMPLE III

### Synthesis of Poly(Dimethyldiallyammonium/PROJET MAGENTA 3BOA) Complex

In the preparation of the poly(dimethyldiallyammonium/PROJET MAGENTA 3BOA) complex, 1 mole of triazine dye was mixed with 5 molar repeat residues (C₈H₆N⁺) of the poly(dimethyldiallyammonium chloride) to yield a precipitate that comprised 5.0 C₈H₆N⁺ residues per mole of triazine dye.

### EXAMPLE IV

### Synthesis of Poly(Dimethyldiallyammonium/ILFORD Y-104) Complex

In the preparation of the poly(dimethyldiallyammonium/ILFORD Y-104) complex, 1 mole of yellow dye was mixed with 5 molar repeat residues (C₈H₆N⁺) of the poly(dimethyldiallyammonium chloride) to yield a precipitate that comprised 3.25 C₈H₆N⁺ residues per mole of yellow dye.

### EXAMPLE V

### Synthesis of Poly(Dimethyldiallyammonium/ILFORD M-377) Complex

In the preparation of the poly(dimethyldiallyammonium/ILFORD M-377 complex, 1 mole of magenta dye was mixed with 5 molar repeat residues (C₈H₆N⁺) of the poly(dimethyldiallyammonium chloride) to yield a precipitate that comprised 3.5 C₈H₆N⁺ residues per mole of yellow dye.

### EXAMPLE VI

### Synthesis of Poly(Dimethyldiallyammonium/Acid Blue 9) Complex

In the preparation of the poly(dimethyldiallyammonium/Acid Blue 9) complex, 1 mole of cyan dye was mixed with 3 molar repeat residues (C₈H₆N⁺) of the poly(dimethyldiallyammonium chloride) to yield a precipitate that comprised 2.0 C₈H₆N⁺ residues per mole of cyan dye.

The inks of Examples VII through X were each prepared by adding the quaternary polymer/dye complex prepared in one of Examples I to VI to a mixture of the other ink ingredients (water, cosolvents, salt, etc.) and agitating the mixture gently until the quaternary polymer/dye complex was dissolved in the solution. This dissolution typically was accomplished within a period of 15 minutes to 2 hours. As a matter of practice, mixtures were commonly agitated overnight (16 hours). The inks were then syringe filtered through a Gelman Laboratory Acrodisc® 37 mm Syringe Filter with a 1 micron Glass Fiber Membrane.

### EXAMPLE VII (COMPARATIVE)

### Yellow Ink Containing Poly(Dimethyldiallylammonium chloride) and Auxiliary Salt, MgCl₂

| | | Amount |
|---|---|---|
| | | (parts by |
| Ingredient | Supplier | weight) |
| deionized water | — | 9.85 |
| sulfolane* | Phillips 66 | 20.0 |
| magnesium chloride | Aldrich Chemical Co. | 10.0 |
| hexahydrate | | |
| 2-pyrrolidinone | Aldrich Chemical Co. | 10.0 |
| poly(diallyldimethylammonium | CP-1030, Nalco | 13.3 |
| chloride)** | Chemical (Calgon) | |
| PROJET ® YELLOW OAM*** dye | Zeneca | 40.0 |
| 1-octyl-2-pyrrolidinone | Aldrich Chemical Go, | 1.0 |

*95 wt. % sulfolane, 5 wt. % water
**aqueous solution containing 33 wt. % polymer solids
***containing 7.5 wt. % Acid Yellow 23 dye solids in water

The ink had a viscosity of 4.58 centipoise, a surface tension of 31.3 dynes per centimeter, a pH of 6.4, and a conductivity of 35 millimhos per centimeter.

### EXAMPLE VIII

### Yellow Ink Containing Poly(DimethyldiallylammoniumlAcid Yellow 23)

Complex and Auxiliary Salt, MaCl₂

| | | Amount |
|---|---|---|
| | | (parts by |
| Ingredient | Supplier | weight) |
| deionized water | — | 53.14 |
| sulfolane* | Phillips 66 | 20.21 |
| magnesium chloride | Aldrich Chemical Co. | 10.11 |
| hexahydrate | | |
| 2-pyrrolidinone | Aldrich Chemical Co. | 10.11 |
| poly(diallyldimethylammonium | Example I | 5.42 |
| chloride)/Acid Yellow 23 | | |
| Complex | | |
| 1-octyl-2-pyrrolidinone | Aldrich Chemical Co. | 1.0 |

*95 wt. % sulfolane, 5 wt. % water

The ink had a viscosity of 3.51 centipoise, a surface tension of 31 dynes per centimeter, a pH of 6.48, and a conductivity of 28.8 millimhos per centimeter.

### EXAMPLE IX (COMPARATIVE)

### Yellow Ink Containing Poly(Dimethyldiallylammonium chloride) and Auxiliary Salt. Choline Chloride

| | | Amount |
|---|---|---|
| | | (parts by |
| Ingredient | Supplier | weight) |
| deionized water | — | 9.85 |
| sulfolane* | Phillips 66 | 20.0 |
| choline chloride | Aldrich Chemical Co. | 10.0 |
| 2-pyrrolidinone | Aldrich Chemical Co. | 10.0 |
| poly(diallyldimethylammonium | OP-1030, Nalco | 13.3 |
| chloride)** | Chemical (Calgon) | |
| PROJET ® YELLOW OAM*** dye | Zeneca | 40.0 |
| 1-octyl-2-pyrrolidinone | Aldrich Chemical Co. | 1.0 |

*95 wt. % sulfolane, 5 wt. % water
**aqueous solution containing 33 wt. % polymer solids
***containing 7.5 wt. % Acid Yellow 23 dye solids in water

The ink had a viscosity of 4.09 centipoise, a surface tension of 31.1 dynes per centimeter, a pH of 7.0, and a conductivity of 28.6 millimhos per centimeter.

### EXAMPLE X

### Yellow Ink Containing Poly(Dimethyldiallylammonium/Acid Yellow 23) Complex and Auxiliary Salt, Choline Chloride

| | | Amount |
|---|---|---|
| | | (parts by |
| Ingredient | Supplier | weight) |
| deionized water | — | 53.05 |
| sulfolane* | Phillips 66 | 20.25 |
| choline chloride | Aldrich Chemical Co. | 10.13 |
| 2-pyrrolidinone | Aldrich Chemical Co. | 10.13 |
| poly(diallyldimethylammonium | Example I | 5.43 |
| chloride)/Acid Yellow 23 | | |
| Complex | | |
| 1-oclyl-2-pyrrolidinone | Aldrich Chemical Co. | 1.0 |

*95 wt. % sulfolane, 5 wt. % water

The ink had a viscosity of 3.16 centipoise, a surface tension of 31.1 dynes per centimeter, a pH of 7.0, and a conductivity of 22.8 millimhos per centimeter.

### TESTING

The following tests were used to gauge the performance of the inks in a thermal ink jet printhead.

The frequency response is the maximum frequency at which a printhead can operate while maintaining a transit time 10 percent greater or less than the transit time measured at 1,000 Hz.

Jitter response is the standard deviation of the average transit time for a drop to travel a distance of 0.5 mm.

The Latency measurement quantifies the change in drop velocity resulting from a change in ink composition at the nozzle face as a result of vehicle evaporation with exposure to the printhead ambient environment. This composition change can cause drop velocity and volume changes, which can produce print quality defects. The Jitter/Transit Time measurement measures drop transit times in microseconds of 500 drops fired at a frequency of 1 KHz. The Jitter number is the standard deviation of the 500-drop transit time.

The Performance Test encompasses a series of measurements that characterize various aspects of jetting behavior in a thermal ink jet printhead. These measurements include Latency (a measurement that quantifies the change in first drop velocity resulting from a change in ink composition at the nozzle face as a result of vehicle evaporation as a function of time of exposure to the printhead ambient environment), Jitter (the standard deviation of the transit time of a series of drops), and Perf Test (a measurement of drop volume and transit time of a bank of nozzles to roughly the design life of an average printhead).

The inks thus prepared were incorporated into a test fixture in which one could detect the ejection of drops from a thermal ink jet print element and measure the velocity of drop ejected therefrom as a function of frequency and time between firing of drops. The apparatus was a laboratory instrument comprising a print element coupled to a test ink supply and a microscope equipped with a video camera/drop sensor, all under synchronous computer control. The instrument and associated software recorded the voltage required to eject a drop (the “Threshold Voltage” is the minimum DC voltage at which a printhead will produce detectable drops), evaluated “Jitter,” the standard deviation of the transit times measured from a burst of 500 drops fired at 1000 Hz, determined the maximum frequency at which the drops could be ejected, evaluated “latency,” the maximum amount of time that could elapse between the ejection of drops (1st and 9th drops) at a drop velocity of greater that 6.25 meters per second (transit time >80 microseconds) from a nozzle bathed with air at a relative humidity of 12 percent. The first missed drop was the time elapsed (up to 500 seconds) before a drop with a velocity greater than 6.25 meters per second was not ejected when a jet was fired.

The jetting data and characteristics were as follows:

| | Threshold | | | Latency | First | Drop | Drop |
|---|---|---|---|---|---|---|---|
| | Voltage | F-max | Jitter | 80 μsec | Missed | Velocity | Volume |
| Ink | (vDC) | (kHz) | (μsec) | fail 1^{st}, 9^{th} | Drop (s) | (m/s) | (pL) |
| Ex. VII | 33.6 | 13.44 | 2.7 | 4, 5 | 5 | 6.6 | 10.5 |
| Ex. VIII | 33.5 | 14 | 3.4 | 7, 1000 | 40 | 7.5 | 11.5 |
| Ex. IX | 32.9 | 7.44 | 1.1 | 5, 14 | 8 | 8.3 | 10.7 |
| Ex. X | 32.9 | 14 | 3.3 | 5, 500 | 20 | 7.2 | 7.2 |

The inks were jetted onto various papers as identified in the table below. Yellow and black images were generated with these inks and with a black ink comprising 20 percent by weight of a 15 percent solids dispersion of a self-dispersing, surface-functionalized carbon black (CABOT® IJX-157), 12.63 percent by weight of sulfolane containing 5 percent water, 8.42 percent by weight of 2-pyrrolidone (containing 5 percent water), 0.60 percent by weight SILWET® 7200, and 58.35 percent by weight deionized water. Optical density of the yellow portions of the images thus formed were measured. Intercolor bleed between the yellow images and black images was measured by evaluating the visual perception of a line edge defect known as raggedness in the spatial frequency range to which the eye is most sensitive, 0 to 8 cycles per millimeter. The value represents the visible mid-frequency defects whose peaks are above the frequency threshold at normal viewing distances.

Mid-frequency line edge noise (MFLEN) was measured using tangential line edge scans. The metric employed a 20×200 micron effective aperture, the length of which was perpendicular to the line. A scan was made parallel to the length of the line in which reflectance values were acquired at increments of 10 microns. The aperture straddled the edge of the line without having the highest or lowest points of the line touch an extreme end of the aperture at any point during the scan. The average reflection value during the scan should be about 50 percent. The difference between the maximum and the minimum reflectance values should be kept to a minimum (skew of the scan along the line). The result of this scan was called the Tangential Edge Profile. Any linear trend was then removed from the TEP. A Fourier Transform was performed to convert the detrended TEP data to the spatial frequency domain (with the use of a weighting factor). The weighted transform of the edge profiles and the threshold human visual response were compared on a point by point basis. In regions where the threshold was exceeded the supra-threshold amounts were summed using a root mean cube procedure. The result was the MFLEN value in root-mean-cubed microns above threshold.

Optical density and intercolor bleed values are indicated for the various inks papers in the table below, with intercolor bleed listed first (ICB/OD):

| Paper | Ex. VII | Ex. VIII | Ex. IX | Ex. X |
|---|---|---|---|---|
| FX KL | 46.9/0.86 | 55.3/0.83 | 52.9/0.86 | 45.1/0.85 |
| CJ1 | 31.3/0.89 | 24.8/0.84 | 20.7/0.88 | 25.4/0.85 |
| CJ3 | 41.6/0.88 | 32.8/0.81 | 34.5/0.89 | 32.3/0.85 |
| CJ4 | 36.89/0.88 | 37.3/0.84 | 36.7/0.89 | 37.3/0.85 |
| CJ5 | 20.3/0.86 | 12.0/0.80 | 12.3/0.86 | 21.1/0.81 |
| CJ6 | 46.7/0.90 | 39.4/0.73 | 50.5/0.89 | 44.5/0.84 |
| CJ8 | 29.8/0.76 | 28.3/0.72 | 28.5/0.79 | 33.9/0.74 |
| CJ9 | 41.9/0.87 | 36.9/0.81 | 42.3/0.83 | 34.8/0.80 |
| CJ10 | 47.9/0.81 | 40.8/0.76 | 43.0/0.83 | 43.8/0.77 |
| CJ11 | 35.2/0,87 | 30.4/0.83 | 39.2/0.91 | 33.9/0.85 |
| CJ12 | 23.7/0.85 | 20.7/0.83 | 31.3/0.89 | 27.6/0.82 |
| CA2 | 18.0/0.82 | 20.5/0.79 | 26.9/0.86 | 41.5/0.82 |
| CA11 | 34.7/0.82 | 32.4/0.81 | 33.3/0.86 | 43.0/0.83 |
| CA14 | 15.2/0.82 | 17.5/0.79 | 12.0/0.85 | 9.4/0.81 |
| CJ7 | 66.5/0.85 | 59.1/0.80 | 53.9/0.85 | 68.6/0.83 |
| CS8 | 22.8/0.85 | 15.7/0.78 | 16.7/0.85 | 20.2/0.83 |
| CE9 | 25.1/0.80 | 30.8/0.78 | 38.4/0.83 | 33.4/0.80 |
| CA12 | 1.8/0.83 | 1.5/0.78 | 4.0/0.83 | 4.1/0.80 |

The papers used were as follows:

| | | Paper |
|---|---|---|
| Paper | Product | Weight |
| CA2 | HAMMERMILL ® COPY PLUS | 20 lb/75 g |
| CA11 | XEROX ® HIGH TECH LASER | 24 lb/90 g |
| CA12 | XEROX ® COLOR XPRESSIONS ® | 24 lb/90 g |
| CA14 | XEROX ® HIGH TECH INK JET (Boise Mill) | 20 lb/75 g |
| CE9 | XL BUSINESS 3R91820 | 80 g |
| CJ1 | FUJI XEROX ® “5” thin copier paper | 56 g |
| CJ3 | FUJI XEROX ® MULTIACE | 63 g |
| CJ4 | FUJI XEROX ® “P” copier paper | 64 g |
| CJ5 | FUJI XEROX ® “J” color copier paper | 82 g |
| CJ6 | FUJI XEROX ® WR (white recycled) | 67 g |
| CJ7 | FUJI XEROX ® WR100 (100% post waste papers) | 67 g |
| CJ8 | YAMAYURI | — |
| CJ9 | FUJI XEROX ® SANKOKUL | — |
| CJ10 | FUJI XEROX ® GREEN 100 | — |
| CS8 | XEROX ® Office Paper | 75 g |
| CJ11 | FUJI XEROX ® HOKUETSUL | — |
| CJ12 | SHARP ® PPC Paper | — |
| FX KL | FUJI XEROX ® KAKUSAKU-L | — |

As the data indicate, inks prepared according to the process of the present invention exhibited improved values for latency and for first missed drop compared to inks of similar composition but not prepared according to the process of the present invention. In addition, the inks prepared according to the process of the present invention in many instances exhibited improved intercolor bleed values compared to inks of similar composition but not prepared according to the process of the present invention.

Other embodiments and modifications of the present invention may occur to those of ordinary skill in the art subsequent to a review of the information presented herein; these embodiments and modifications, as well as equivalents thereof, are also included within the scope of this invention.

The recited order of processing elements or sequences, or the use of numbers, letters, or other designations therefor, is not intended to limit a claimed process to any order except as specified in the claim itself.

What is claimed is:

1. A process which comprises (a) preparing a first solution comprising water and an anionic dye; (b) preparing a second solution comprising water and a polyquaternary amine compound; (c) admixing the first solution and the second solution, thereby causing formation of a complex of the anionic dye and the polyquaternary amine compound and precipitation of the complex from the solution; and (d) isolating the complex thus formed.

2. A process according to claim 1 wherein the polyquaternary amine compound is of the formulae 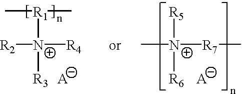
wherein n is an integer representing the number of repeat monomer units, R₁ and R₇ each, independently of the other, is an alkylene group, an arylene group, an arylalkylene group, or an alkylarylene group, and R₂, R₃, R₄, R₅, and R₆ each, independently of the others, are hydrogen atoms, alkyl groups, aryl groups, arylalkyl groups, or alkylaryl groups.

3. A process according to claim 1 wherein the polyquaternary amine compound is selected from the group consisting of polydiallyl ammonium compounds, polyquaternized polyvinylamines, polyquaternized polyallylamines, epichlorohydrin/amine copolymers, cationic amido amine copolymers, copolymers of vinyl pyrrolidinone and a vinylimidazolium salt, and mixtures thereof.

4. A process according to claim 1 wherein the polyquaternary amine compound is a polydiallyl dimethyl ammonium compound.

5. A process according to claim 1 wherein the anionic dye is (a) Acid Yellow 23, (b) Acid Red 52, (c) a magenta chlorotriazine dye with a molecular weight of 881 grams per mole and an empirical formula of C₃₀H₂₀ClN₇O₁₅S₄, (d) a dye of the formula 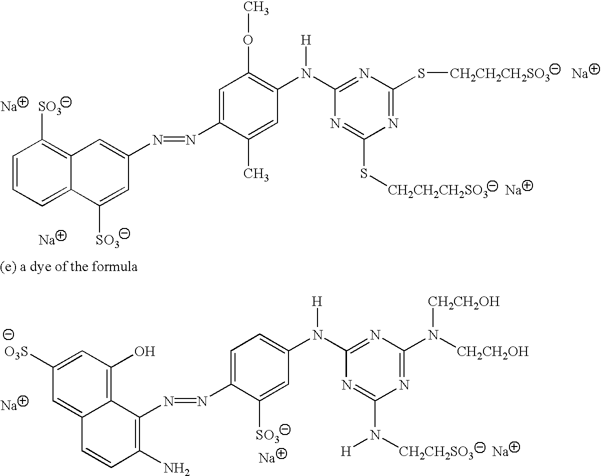
(f) Acid Blue 9, (g) Direct Blue 199, or (h) mixtures thereof.

6. A process for preparing an ink composition which comprises (1) preparing a complex of an anionic dye and a polyquaternary amine compound by a process which comprises (a) preparing a first solution comprising water and an anionic dye, (b) preparing a second solution comprising water and a polyquaternary amine compound; and (c) admixing the first solution and the second solution, thereby causing formation of a complex of the anionic dye and the polyquaternary amine compound and precipitation of the complex from the solution, and (2) admixing the complex thus formed with an organic cosolvent.

7. A process according to claim 6 wherein the cosolvent is selected from the group consisting of ethylene glycol, propylene glycol, diethylene glycols, glycerine, dipropylene glycols, polyethylene glycols, polypropylene glycols, amides, ethers, urea, substituted ureas, ethers, carboxylic acids and their salts, esters, alcohols, organosulfides, organosulfoxides, sulfones, alcohol derivatives, carbitol, butyl carbitol, cellusolve, tripropylene glycol monomethyl ether, ether derivatives, amino alcohols, ketones, N-methylpyrrolidinone, 2-pyrrolidinone, cyclohexylpyrrolidone, hydroxyethers, amides, sulfoxides, lactones, polyelectrolytes, methyl sulfonylethanol, imidazole, betaine, and mixtures thereof.

8. A process according to claim 6 wherein the complex is further admixed with a nonpolymeric salt.

9. A process according to claim 8 wherein the nonpolymeric salt is present in the ink in an amount of at least about 0.1 percent by weight of the ink, and wherein the nonpolymeric salt is present in the ink in an amount of no more than about 40 percent by weight of the ink.

10. A composition comprising a complex of an anionic dye and a polyquaternary amine compound prepared by the process of claim 1.

11. A composition according to claim 10 wherein the polyquaternary amine is a poly(dimethyldiallyl ammonium) compound and the anionic dye is Acid Yellow 23.

12. A composition according to claim 10 wherein the polyquaternary amine is a poly(dimethyldiallyl ammonium) compound and the anionic dye is Acid Red 52.

13. A composition according to claim 10 wherein the polyquaternary amine is a poly(dimethyldiallyl ammonium) compound and the anionic dye is a magenta chlorotriazine dye having a molecular weight 881 grams per mole and an empirical formula of C₃₀H₂₀ClN₇O₁₅S₄.

14. A composition according to claim 10 wherein the polyquaternary amine is a poly(dimethyldiallyl ammonium) compound and the anionic dye is of the formula

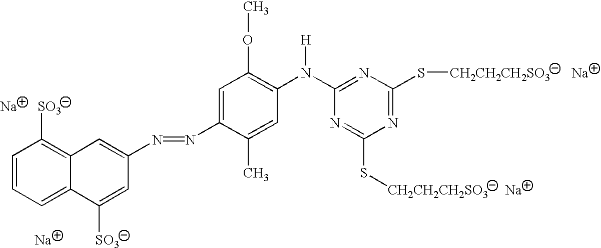

15. A composition according to claim 10 wherein the polyquaternary amine is a poly(dimethyldiallyl ammonium) compound and the anionic dye is of the formula

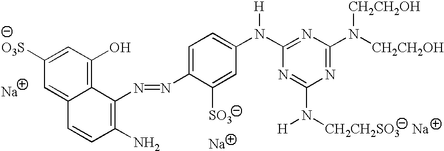

16. A composition according to claim 10 wherein the polyquaternary amine is a poly(dimethyldiallyl ammonium) compound and the anionic dye is Acid Blue 9.

17. A composition according to claim 10 wherein the polyquaternary amine is a poly(dimethyldiallyl ammonium) compound and the anionic dye is Direct Blue 199.

18. A composition according to claim 10 wherein the polyquaternary amine is a copoly(N-vinyl-N-methylimidazolium chloride/N-vinylpyrrolidone) and the anionic dye is of the formula

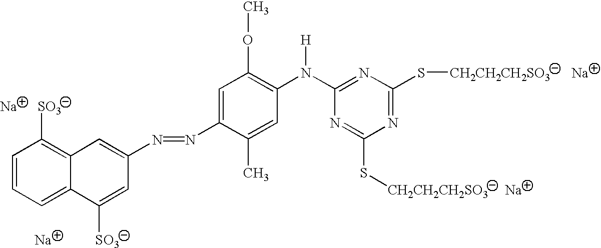

19. A process which comprises:
(A) preparing an ink composition by a process comprising:
(1) preparing a complex of an anionic dye and a polyquaternary amine compound by a process which comprises:
(a) preparing a first solution comprising water and an anionic dye;
(b) preparing a second solution comprising water and a polyquaternary amine compound; and
(c) admixing the first solution and the second solution, thereby causing formation of a complex of the anionic dye and the polyquaternary amine compound and precipitation of the complex from the solution; and
(2) admixing the complex thus formed with an organic cosolvent; and
(B) incorporating the ink composition into an ink jet printing apparatus and causing droplets of the ink composition to be ejected in an imagewise pattern onto a substrate.

20. A process according to claim 19 wherein the printing apparatus employs a thermal ink jet process wherein the ink in the nozzles is selectively heated in an imagewise pattern, thereby causing droplets of the ink to be ejected in imagewise pattern.
